(19) United States
(12) Patent Application Publication
(10) Pub. No.: US 2017/0009704 A1
(43) Pub. Date: Jan. 12, 2017

(54) THRUST REVERSER STAGGERED TRANSLATING SLEEVE

(71) Applicant: Rohr, Inc., Chula Vista, CA (US)

(72) Inventor: Landy Dong, San Diego, CA (US)

(21) Appl. No.: 14/792,227

(22) Filed: Jul. 6, 2015

(51) Int. Cl. F02K 1/76

(52) U.S. Cl. CPC F02K 1/766

(57) ABSTRACT

Aspects of the disclosure are directed to a thrust reverser of an aircraft. Aspects are directed to a first array of cascades, a second array of cascades, and a sleeve configured to selectively block or unblock the first and second arrays of cascades. The sleeve may be configured such that when the thrust reverser is stowed a first portion of an interface associated with the sleeve is at a first axial location and a second portion of the interface is at a second axial location that is different from the first axial location. The first axial location may substantially coincide with a first circumferential positioning of the first array of cascades and the second axial location may substantially coincide with a second circumferential positioning of the second array of cascades.

### BACKGROUND

A typical cascade-style, translating sleeve thrust reverser for a turbofan propulsion system includes a circumferential array of cascades. Cascades are frequently grill- or grate-like structures through which the majority of the fan bypass air from the propulsion system passes through during reverse thrust operation. The cascades shapes the efflux of air in predetermined directions to produce reverse thrust whilst at the same time ensuring acceptable engine re-ingestion and aircraft stability and control is maintained during reverse operation. Often, a cascade array will contain low forward-turning vanes in a lower, inboard quadrant of the thrust reverser, and high forward-turning vanes in other quadrants (of course, other variations may be possible to suit the particular needs of a given aircraft). The low forward-turning vane cascades direct air outward from the thrust reverser, but only slightly forward, to avoid engine re-ingestion and fuselage-mounted instrumentation efflux impingement from occurring. High forward-turning vane cascades direct air outward and in a more forward direction to generate reverse thrust more efficiently than the low forward-turning vane cascades.

This disclosure proposes an improved packaging solution for a thrust reverser with both low forwarding-turning vane cascades and high forward-turning vane cascades.

### BRIEF SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure are directed to a system configured for use in connection with a thrust reverser of an aircraft, comprising a first array of cascades, a second array of cascades, a sleeve configured to selectively block or unblock the first and second arrays of cascades, where the sleeve is configured such that when the thrust reverser is stowed a first portion of an interface associated with the sleeve is at a first axial location and a second portion of the interface is at a second axial location that is different from the first axial location, where the first axial location substantially coincides with a first circumferential positioning of the first array of cascades and the second axial location substantially coincides with a second circumferential positioning of the second array of cascades. In some embodiments, the first axial location is further aft than the second axial location. In some embodiments, the first array of cascades are configured to project a first efflux plume in generating reverse thrust, and the second array of cascades are configured to project a second efflux plume in generating reverse thrust. In some embodiments, the first array of cascades are configured to project the first efflux plume in a forward direction in a first amount, and the second array of cascades are configured to project the second efflux plume in the forward direction in a second amount. In some embodiments, the second amount is greater than the first amount. In some embodiments, a third portion of the interface couples the first portion of the interface and the second portion of the interface. In some embodiments, the third portion of the interface is substantially perpendicular to the first portion of the interface. In some embodiments, the third portion of the interface is substantially perpendicular to the second portion of the interface. In some embodiments, the second portion of the interface corresponds to a split line between the sleeve and a cowl of a fan case. In some embodiments, the system further comprises a structural member located towards an aft end of the cowl. In some embodiments, the structural member is positioned at substantially the first circumferential positioning of the first array of cascades. In some embodiments, the structural member is configured as a stationary panel that is separate from the cowl. In some embodiments, the structural member is configured as an extension of the cowl. In some embodiments, the first cascades are configured to project an efflux plume in generating reverse thrust, and when the thrust reverser is fully deployed the sleeve is clear of the efflux plume.

Aspects of the disclosure are directed to a system configured for use in connection with a thrust reverser of an aircraft, comprising a first array of cascades, a second array of cascades, a translating sleeve configured to selectively block or unblock the first and second arrays of cascades, where when the thrust reverser is stowed a forward edge of the sleeve is staggered so as to be positioned at a first axial location and a second axial location, where the first axial location substantially coincides with a first circumferential positioning of the first array of cascades and the second axial location substantially coincides with a second circumferential positioning of the second array of cascades. In some embodiments, the first axial location is further aft than the second axial location. In some embodiments, the first array of cascades are configured to project a first efflux plume in a forward direction in a first amount in generating reverse thrust, and the second array of cascades are configured to project a second efflux plume in the forward direction in a second amount in generating reverse thrust, and the second amount is greater than the first amount. In some embodiments, the sleeve is configured to translate in a forward direction to block the first and second arrays of cascades, and the sleeve is configured to translate in an aft direction to unblock the first and second arrays of cascades. In some embodiments, the system further comprises a blocker door configured to redirect at least a first portion of a bypass flow through the first cascades and a second portion of the bypass flow through the second cascades when the thrust reverser is deployed.

### BRIEF DESCRIPTION OF THE DRAWINGS

The present disclosure is illustrated by way of example and not limited in the accompanying figures in which like reference numerals indicate similar elements.

FIG. 1A illustrates a system flow field for high forward-turning vane cascades in accordance with the prior art.

FIG. 1B illustrates a system flow field for low forward-turning vane cascades in accordance with the prior art.

FIGS. 2A-2B illustrate a thrust reverser incorporating a staggered leading edge in accordance with aspects of this disclosure.

FIG. 3 illustrates a system flow field for low forward-turning vane cascades with a staggered translating sleeve leading edge in accordance with aspects of this disclosure.

### DETAILED DESCRIPTION

It is noted that various connections are set forth between elements in the following description and in the drawings (the contents of which are included in this disclosure by way of reference). It is noted that these connections are general and, unless specified otherwise, may be direct or indirect and that this specification is not intended to be limiting in this respect. A coupling between two or more entities may refer to a direct connection or an indirect connection. An indirect connection may incorporate one or more intervening entities.

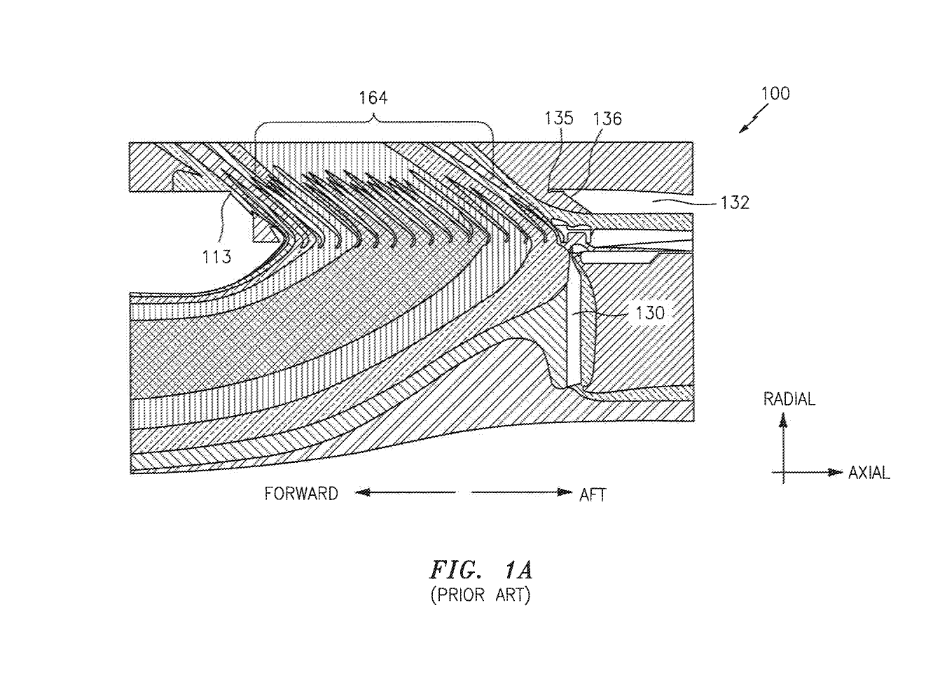

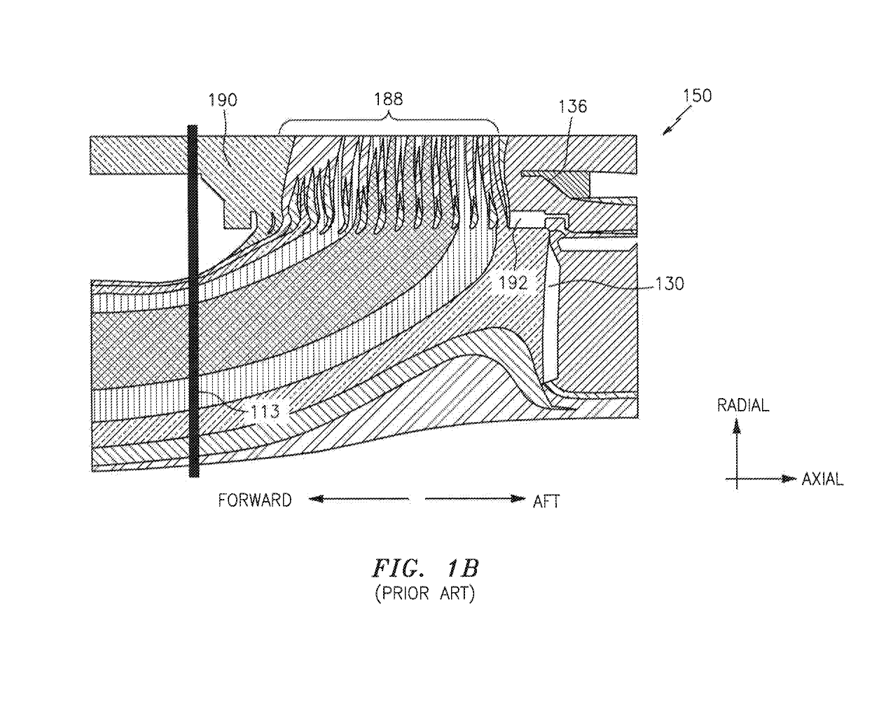

FIG. 1A illustrates a schematic, two-dimensional (2-D) representation of a prior art cascade-style, translating sleeve thrust reverser having a translating sleeve 132, a cascade array 164, and a blocker door 130. This simple, 2-D model, along with other structure to sufficiently define the bypass air duct and boundary conditions, can be used to model to the efflux of air through the thrust reverser during reverse thrust operation through a picture of the system flow field 100. In FIG. 1A, the cascade array 164 is a high forward-turning vane array, and the thrust reverser is in its deployed position where the blocker door 130 redirects air through the cascade array 164 which has been exposed by the aft translation of the translating sleeve 132. The efflux of air from the cascade array 164 is in the forward direction as well as radially outward to generate reverse thrust. In order to avoid buffeting and other potential aerodynamic problems, note that the system structure is arranged such that the efflux does not impinge upon any structure near the split line of the translating sleeve 132 with a fan cowl trailing edge at 113, nor upon the leading edge 135 of the translating sleeve outer panel 136.

In FIG. 1B, a system flow field 150 for low forward-turning vane cascade array 188 in accordance with the prior art is shown. This flow field 150 is based on the same conditions and generally the same model as was used for FIG. 1A, but here the cascade array 188 has low forward-turning vanes. Both cascade arrays 164 and 188 have the same axial length. As in FIG. 1A, here the thrust reverser is deployed and in reverse thrust operation. Note that near reference character 190 the efflux is relatively far away from impingement with structure near the split line 113. Because of the difference in the angle of the forward-turning vanes, the air “fills” the cascade baskets differently compared to FIG. 1A, especially at the first, forward-most basket nearest the split line 113, where hardly any air passes through. Reference character 192 denotes a blockage of what would be the aft-most basket of the cascade array 188. This basket is blocked because otherwise the low forward-turning angle of the vanes would direct efflux to impinge upon the translating sleeve outer panel leading edge 136. The blockage 192 and the lack of air “fill”in the forward-most basket of the array 188 together degrade the performance or efficiency of the thrust reverser in terms of, e.g., production of reverse thrust.

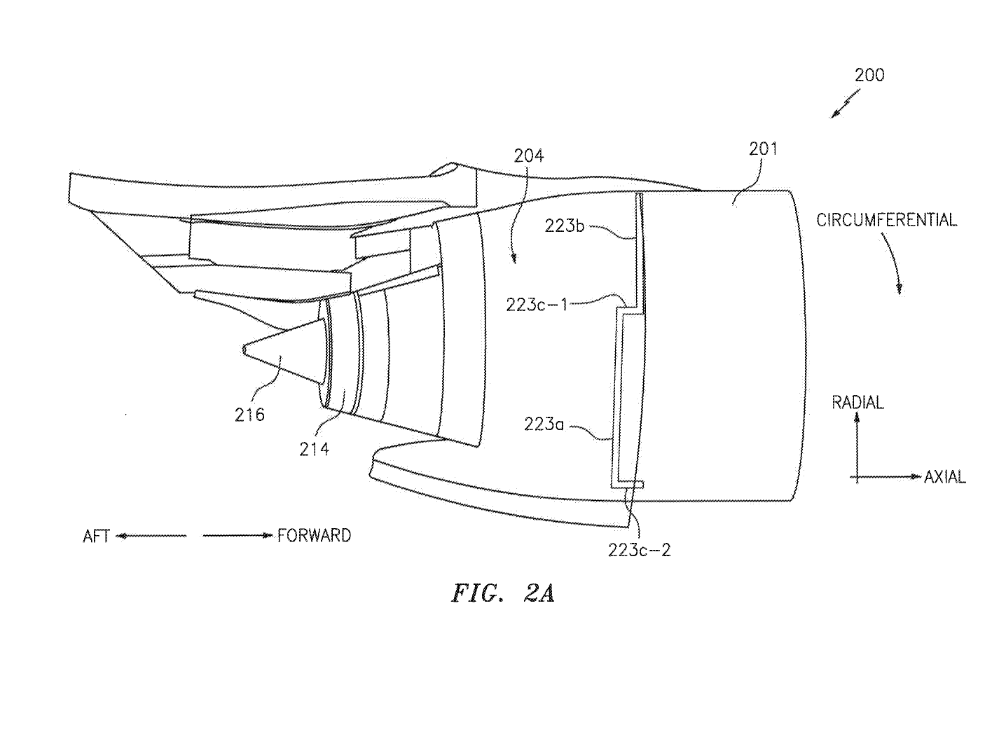

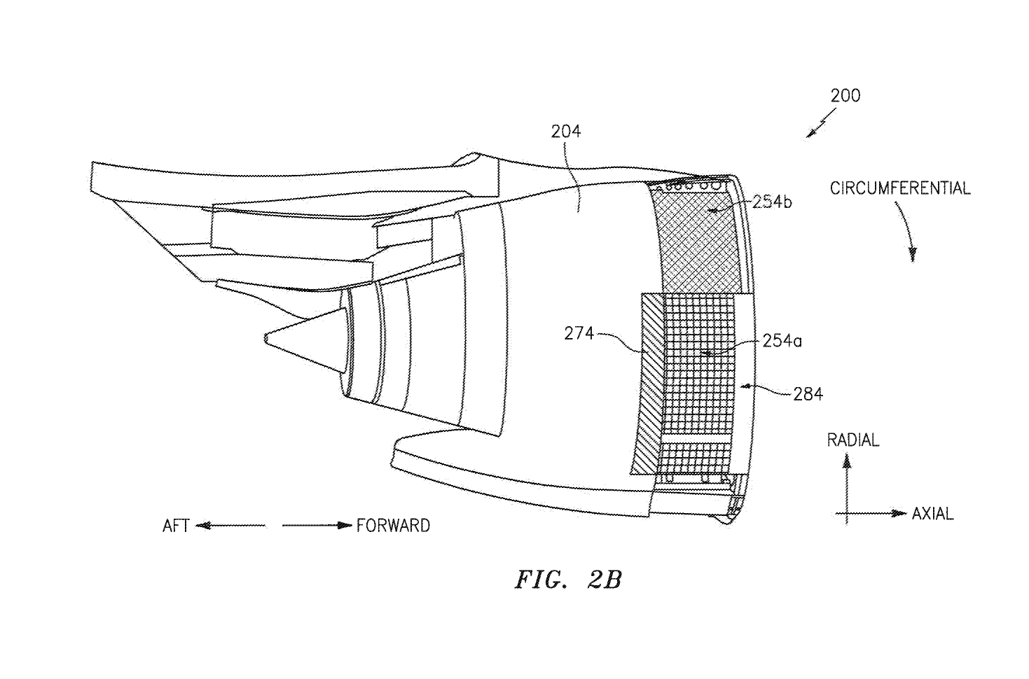

Referring now to FIGS. 2A-2B, art exemplary nacelle 200 is shown. Forward, aft, radial, axial, and circumferential directions are shown for reference purposes.

The nacelle 200 may include one or more of a fan cowl 201 a thrust reverser, an exhaust nozzle 214 and a centerbody 216. The fan cowl 201 generally overlaps a fan case 202 which helps define a radially exterior surface of the fan duct. The thrust reverser is aft of the fan case 202 and defines the remainder of the fan duct until the fan bypass air exits the propulsion system through a bypass air nozzle. The thrust reverser includes a translating sleeve 204.

The sleeve 204 may be configured to translate in the forward or aft direction. FIG. 2A shows the sleeve 204 in its most forward orientation, which may coincide with the thrust reverser being in a stowed state. When the sleeve 204 is positioned as shown in FIG. 2A, the sleeve 204 blocks an array of cascades. When the sleeve 204 is positioned as shown in FIG. 2A, the leading/forward edge of the outer panel of sleeve 204 is in proximity to/abuts the trailing edge of the fan cowl 201.

FIG. 29 shows the sleeve 204 translated aft relative to the position of the sleeve 204 in FIG. 2A. When the sleeve 204 is positioned as shown in FIG. 2B, which may coincide with a deployment of the thrust reverser, cascades 254a and 254b may be unblocked such that fan bypass air from the fan duct may be redirected by blocker doors through the cascades to generate reverse thrust.

The cascades 254a and 254b may be representative of one or more arrays of cascades. In embodiments where the nacelle 200 is coupled to the wing of an aircraft, the cascades 254b may be positioned closer to the wing than the cascades 254a.

The cascades 254a may be low forward-turning vane cascades and the cascades 254b may be high forward-turning vane cascades.

In accordance with many conventional nacelle designs, an interface/split line between the trailing edge of the fan cowl 201 and the leading edge of the outer panel of the sleeve 204 when the thrust reverser is stowed may generally be located at a single axial location over the circumference of the nacelle.

In comparison, in FIG. 2A, a profile/shape of the interface/split line between the fan cowl and the sleeve may be modified such that a portion of the split line is staggered and at a different axial position/station plane compared to the remainder of the split line. This modified profile for the split line is reflected by reference characters 223a, 223b, 223c-1, and 223c-2 (collectively referred to herein as interface/split line 223).

The portion 223b of the split line 223 may be associated/coincide with the interface between the fan cowl 201 and the sleeve 204, radially outward from the cascades 254b. The portion 223a of the split line 223 may be associated with (or coincident with) the cascades 254a. The portion 223a may be at a different axial position relative to the portion 223h; for example, the portion 223a may be located further aft than the portion 223b. The portion 223c-1 may join the portions 223a and 223b. In FIG. 2A, the portions 223c-1 and 223c-2 are shown as being substantially perpendicular to the portions 223a and 223b. Such a configuration illustrates one example of a transitional profile for a split line that may be used. Other shapes/profiles for a split line may be used in some embodiments.

In view of the shape/profile of the split line 223 of FIG. 2A, the sleeve 204 may be modified (relative to conventional sleeve designs/implementations) to accommodate the split line 223. In particular, reference character 274 in FIG. 2B denotes a “cut-out” in the sleeve 204, which is to say that material that might otherwise have been associated with the sleeve 204 in the region 274 may be omitted. To account for the absence of sleeve structure/material in the region 274, a fairing 284 may be attached to the thrust reverser fixed structure, or may be added to the fan cowl 201 such that no appreciable gap may exist on the exterior of the nacelle 200 when the thrust reverser is stowed. The fixed fairing 284 may be configured as a separate, stationary panel attached to the thrust reverser fixed structure, or may be configured as an extension of the fan cowl 201.

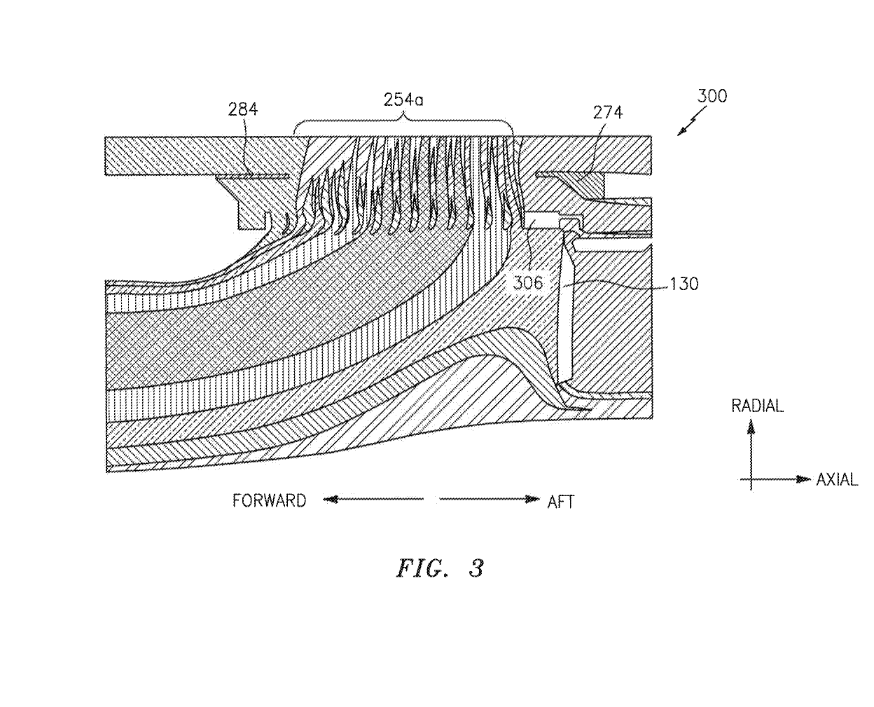

Referring now to FIG. 3, a system flow field 300 generated using a 2-D model representative of the thrust reverser of FIGS. 2A-2B is shown. The low forward-turning vane cascade array 254a is modeled, along with a translating sleeve outer panel leading edge with a staggered split line and a fixed fairing 284. The cascade array 254a may have the same axial length as the cascade array 254b. The all-most cascade basket 306 is unblocked because of the relatively aft position of the translating sleeve outer panel leading edge to avoid any impingement. This open basket 306 can now permit air flow through it. The fixed fairing 284 is not impinged by any appreciable efflux of air from the cascade array 254a, as shown, and so does not degrade performance.

In general, with high and low forward-turning vane arrays of the same axial length, the staggering and aft transposition of the translating sleeve outer panel leading edge over the low forward-turning vane array eliminates the need to block some of the aft most cascade baskets. Because the air flow is increased compared to a cascade array design where some of the baskets must be blocked, the overall dimension of the array may be reduced, and the overall size and weight of the thrust reverser will be correspondingly minimized.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one of ordinary skill in the art will appreciate that the steps described in conjunction with the illustrative figures may be performed in other than the recited order, and that one or more steps illustrated may be optional in accordance with aspects of the disclosure.

I claim:

1. A system configured for use in connection with a thrust reverser of an aircraft, comprising:
a first array of cascades;
a second array of cascades;
a sleeve configured to selectively block or unblock the first and second arrays of cascades,
wherein the sleeve is configured such that when the thrust reverser is stowed a first portion of an interface associated with the sleeve is at a first axial location and a second portion of the interface is at a second axial location that is different from the first axial location,
wherein the first axial location substantially coincides with a first circumferential positioning of the first array of cascades and the second axial location substantially coincides with a second circumferential positioning of the second array of cascades.

2. The system of claim I, wherein the first axial location is further aft than the second axial location.

3. The system of claim 1, wherein the first array of cascades are configured to project a first efflux plume in generating reverse thrust, and wherein the second array of cascades are configured to project a second efflux plume in generating reverse thrust.

4. The system of claim 3, wherein the first array of cascades are configured to project the first efflux plume in a forward direction in a first amount, and wherein the second array of cascades are configured to project the second efflux plume in the forward direction in a second amount.

5. The system of claim 4, wherein the second amount is greater an the first amount.

6. The system of claim 1, wherein a third portion of the interface couples the first portion of the interface and the second portion of the interface.

7. The system of claim 6, wherein the third portion of the interface is substantially perpendicular to the first portion of the interface.

8. The system of claim 7, wherein the third portion of the interface is substantially perpendicular to the second portion of the interface.

9. The system of claim 6, wherein the third portion of the interface is substantially perpendicular to the second portion of the interface.

10. The system of claim 1, wherein the second portion of the interface corresponds to a split line between the sleeve and a cowl of a fan case,

11. The system of claim 10, further comprising:
a structural member located towards an aft end of the cowl,

12. The system of claim 11, wherein the structural member is positioned at substantially the first circumferential positioning of the first array of cascades.

13. The system of claim 11, wherein the structural member is configured as a stationary panel that is separate from the cowl.

14. The system of claim 11, wherein the structural member is configured as an extension of the cowl.

15. The system of claim I, wherein the first cascades are configured to project an efflux plume in generating reverse thrust, and wherein when the thrust reverser is fully deployed the sleeve is clear of the efflux plume.

16. A system configured for use in connection with a thrust reverser of an aircraft, comprising:
a first array of cascades;
a second array of cascades;
a translating sleeve configured to selectively block or unblock the first and second arrays of cascades,
wherein when the thrust reverser is stowed a forward edge of the sleeve is staggered so as to be positioned at a first axial location and a second axial location,
wherein the first axial location substantially coincides with a first circumferential positioning of the first array of cascades and the second axial location substantially coincides with a second circumferential positioning of the second array of cascades.

17. The system of claim 16, wherein the first axial location is further aft than the second axial location.

18. The system of claim 16, wherein the first array of cascades are configured to project a first efflux plume in a forward direction in a first amount in generating reverse thrust, and wherein the second array of cascades are configured to project a second efflux plume in the forward direction in a second amount in generating reverse thrust, and wherein the second amount is greater than the first amount.

19. The system of claim 16, wherein the sleeve is configured to translate in a forward direction to block the first and second arrays of cascades, and wherein the sleeve is configured to translate in an aft direction to unblock the first and second arrays of cascades.

20. The system of claim 16, further comprising:
a blocker door configured to redirect at least a first portion of a bypass flow through the first cascades and a second portion of the bypass flow through the second cascades when the thrust reverser is deployed.
